(19) United States
(12) Patent Application Publication
(10) Pub. No.: US 2009/0019899 A1
(43) Pub. Date: Jan. 22, 2009

(54) GUARD ANTI-ROTATION LOCK

(76) Inventors: Cornelius Boeck, Kirchheim (DE); Joachim Schadow, Leinfelden-Echterdingen (DE); Sinisa Andrasic, Schoenaich (DE)

Correspondence Address: MICHAEL J. STRIKER, 103 EAST NECK ROAD, HUNTINGTON, NY, 11743, US

(21) Appl. No.: 12/280,009

(22) PCT Filed: Nov. 9, 2007
(86) PCT No.: PCT/EP2007/062104

§ 371 Date: Aug. 20, 2008

(30) Foreign Application Priority Data
Nov. 13, 2006 (DE) 10 2006 053 305.4

(51) Int. Cl. E05B 65/00

(52) U.S. Cl. 70/61

(57) ABSTRACT

The invention relates to a protective hood anti-rotation lock for a portable power tool (12a-e), especially an angle grinder. Said protective hood anti-rotation lock is characterized in that it comprises an anti-rotation unit (14a-e) that is adapted to take into consideration at least one operating parameter of the portable power tool (12a-e) during anti-rotational locking.

### RELATED ART

The present invention is directed to a guard anti-rotation lock according to the preamble of Claim 1.

Publication EP 812 657 A1 makes known an angle grinder with an adjustable guard. In that case, the guard is adjustable in a rotating manner on a connection piece of a flange of the angle grinder, and is supported such that it may be detachably attached using a single form-fit locking means. The spindle of the angle grinder passes through the center of the flange. A cutting and/or grinding disk is installed on the free end of the spindle in a clampable, rotationally drivable manner for cutting and machining work pieces, which are partially enclosed by the guard. The guard must be positioned in a rotationally adjustable manner on the hand-held power tool such that the region of the grinding disk that faces the user is enclosed by the guard. At the same time, a region of the grinding disk that points away from the user extends past the flange, radially relative to the work piece engagement.

### ADVANTAGES OF THE INVENTION

The present invention relates to a guard anti-rotation lock for a hand-held power tool, in particular for an angle grinder.

It is provided that the guard anti-rotation lock includes a rotation lock unit, which is provided to take into account at least one operating parameter of the hand-held power tool when preventing rotation. The anti-rotation lock unit of the guard anti-rotation lock is preferably provided to prevent rotation between a guard and/or a guard together with a clamping band and the hand-held power tool, in particular a hand-held power tool receiving unit of the hand-held power tool. Due to the inventive design of the guard anti-rotation lock, it is possible to effectively protect an operator of the hand-held power tool from a—disk-shaped in particular—tool, which rotates during operation of the hand-held power tool, and/or, in particular, from parts of the tool that are slung in the direction of the operator if the tool becomes damaged, e.g., if the tool should burst. The operating parameter preferably includes an active state of the hand-held power tool, so that the anti-rotation lock unit is provided to account for an active state of the hand-held power tool, thereby making it advantageously possible to protect an operator during operation of the hand-held power tool. The active state of the hand-held power tool is advantageously a torque of a tool and/or a drive torque of a drive shaft for driving the tool, and/or a switched-on state of a motor unit of the hand-held power tool.

It is also provided that the anti-rotation lock unit is provided to prevent rotation between a guard unit and the hand-held power tool during a breakdown of the tool. In this context, “provided” is intended to mean, in particular, specially equipped and/or designed. In addition, a “breakdown of the tool” is intended to mean, in particular, a tool that bursts during operation of the hand-held power tool, in which case individual tool parts may be slung outwardly due to rotation of the tool, and the outwardly slung tool parts are preferably captured by the guard unit. Advantageously, a sizing of the anti-rotation lock unit is designed to absorb forces that occur when the tool becomes damaged, these forces being transferred from tool parts that strike the guard unit to the guard unit itself. A position of the guard unit is preferably maintained when the tool becomes damaged via the anti-rotation lock unit and proper functioning of the guard unit. The inventive design provides reliable protection of the operator during operation of the hand-held power tool by ensuring that an advantageous protective position of the guard unit may be retained on the hand-held power tool in a non-rotatable manner during the breakdown.

A particularly effective anti-rotation lock during operation of the hand-held power tool between the guard unit and the hand-held power tool may be attained when the guard anti-rotation lock includes a form-fit unit, which is provided to establish a form-fit connection between the guard unit and the hand-held power tool.

Furthermore, a hand-held power tool, in particular an angle grinder, with a guard anti-rotation lock is provided, the anti-rotation lock unit including at least one anti-rotation lock element that is located on a hand-held power tool housing and/or a hand-held power tool receiving unit, by way of which a rotation lock with a simple design may be realized. The term “located” is intended to mean, in particular, that the anti-rotation lock element is fastened to and/or movably supported on the hand-held power tool housing and/or the hand-held power tool receiving unit. The anti-rotation lock element may be proved to establish a non-positive and/or—particularly advantageously—a form-fit anti-rotation lock between the guard unit and the hand-held power tool, in particular in that the anti-rotation lock element is designed as a form-fit element, e.g., a bolt and/or a toothing and/or further form-fit elements that appear reasonable to one skilled in the technical art.

A particularly easy means for attaching and removing the guard unit to/from the hand-held power tool may be advantageously attained when the anti-rotation lock element is movably located on the hand-held power tool housing and/or the hand-held power tool receiving unit. The anti-rotation lock element is preferably moved into an anti-rotation lock position at the start of operation, and it is moved out of the anti-rotation lock position and into an inactive position after operation of the hand-held power tool and/or the tool, in particular when the hand-held power tool is in an active state. In the inactive position, an anti-rotation lock between the guard unit and the hand-held power tool is advantageously released.

In an alternative embodiment of the present invention, it is provided that the anti-rotation lock unit includes at least one rotatably supported lever element on which the anti-rotation lock element is at least partially located, by way of which the anti-rotation lock element may be advantageously moved into an anti-rotation lock position and/or into an inactive position using the lever element.

It is also provided that the anti-rotation lock unit includes a fan, which is provided to generate an air flow for moving the lever element into an anti-rotation lock position, thereby making it advantageously possible to couple the anti-rotation lock to an operation—in particular an active state—of the hand-held power tool and/or the tool. The fan is preferably driven during operation by a shaft that is provided to transfer drive torque to the tool.

When the lever element also includes—at least partially—a chamber-like recess on a side that faces the fan, it is possible to reinforce an effect of the force of the air flow on the lever element using a simple design, in order to move the lever element and/or the anti-rotation lock element that is located on the lever element.

It is also provided that the anti-rotation lock unit includes a shaft with an eccentric element, which is provided to move the anti-rotation lock element into an anti-rotation lock position, thereby making it advantageously possible to couple the anti-rotation lock to an operation and/or an active state of the hand-held power tool. The shaft may be designed as a single piece with a drive shaft for driving the tool, or, particularly advantageously, it may be a shaft that is separate from the drive shaft and that is preferably coupled to a transfer of torque from the drive shaft and/or that is non-rotatably located on the drive shaft. An “eccentric element” is intended to mean, in particular, an element that is preferably located on the shaft in an eccentric manner and that presses the anti-rotation lock element into an anti-rotation lock position when the shaft rotates. Particularly advantageously, the eccentric element is designed as a leaf spring, thereby making it possible to reduce wear on the anti-rotation lock element and/or the eccentric element, in particular due to friction between the anti-rotation lock element and the eccentric element.

When the anti-rotation lock unit includes at least one restoring element that is designed to move the anti-rotation lock element into an inactive position, it is advantageously possible to release an anti-rotation lock between the guard unit and the hand-held power tool in a switched-off operating mode, and/or in an inactive state of the hand-held power tool, so that the guard unit may be removed by an operator of the hand-held power tool. In this context, an “inactive position” is intended to mean, in particular, a position of the anti-rotation lock element in which an anti-rotation lock between the guard unit and the hand-held power tool is advantageously released. The restoring element is designed as a magnet and/or, particularly advantageously, by a spring element, and/or by other restoring elements that appear reasonable to one skilled in the technical art.

In an advantageous refinement of the present invention, a guard unit with a guard anti-rotation lock is provided, the anti-rotation lock unit including at least one anti-rotation lock element that is located on a guard and/or a clamping band, by way of which a rotation lock between the guard unit and the hand-held power tool may be realized using a simple design. The guard unit preferably includes a guard and a closing unit with a clamping band.

It is also provided that the anti-rotation lock element is designed as a form-fit element that is provided to establish a form-fit connection with the hand-held power tool, thereby making it possible to attain a particularly effective anti-rotation lock between the guard unit and the hand-held power tool, even in the presence of strong forces—tangential forces, in particular—that act on the guard unit. This may be attained in a particularly advantageous manner when the form-fit element is designed as a recess. Any other form-fit elements that appear reasonable to one skilled in the technical art are also feasible in an alternative embodiment, of course.

When the anti-rotation lock unit includes at least two anti-rotation lock elements that are located one after the other in the circumferential direction, a reusable form-fit and/or non-positive connection between the guard unit and the hand-held power tool may be attained, and/or the guard unit may be advantageously and non-rotatably installed in different positions along the circumferential direction on the hand-held power tool. The term “circumferential direction” is intended to mean, in particular, a circumferential direction of the guard unit, which is oriented essentially parallel to a direction of rotation of the tool when the guard unit is in an installed state.

In an advantageous refinement of the present invention, a hand-held power tool system is provided with a hand-held power tool, in particular an angle grinder that includes a hand-held power tool receiving unit for receiving a disk-shaped tool, and with a guard unit and a guard anti-rotation lock that includes an anti-rotation lock unit that is provided to couple—at least partially—an anti-rotation lock between the guard unit and the hand-held power tool to an operating parameter of the hand-held power tool. It is possible to effectively protect an operator of the hand-held power tool from a—disk-shaped in particular—tool, which rotates during operation of the hand-held power tool, and/or, in particular, from parts of the tool that are slung in the direction of the operator if the tool becomes damaged, e.g., if the tool should burst. The operating parameter preferably includes an active state of the hand-held power tool, so that the anti-rotation lock unit is provided to account for an active state of the hand-held power tool, thereby making it advantageously possible to protect an operator during operation of the hand-held power tool. The active state of the hand-held power tool is advantageously a torque of a tool and/or a drive torque of a drive shaft for driving the tool, and/or a switched-on state of a motor unit of the hand-held power tool.

It is also provided that the anti-rotation lock unit includes at least one anti-rotation lock element that is located on a hand-held power tool housing and/or a hand-held power tool receiving unit, by way of which a particularly easy means for attaching and removing the guard unit may be advantageously attained. The anti-rotation lock element may be provided to establish a non-positive anti-rotation lock, and particulary advantageously, a form-fit anti-rotation lock between the guard unit and the hand-held power tool.

A particularly advantageous anti-rotation lock of the guard unit on the hand-held power tool that is coupled to a transfer of a drive torque from a motor unit of the hand-held power tool to a tool and/or an operation, in particular an active state of the hand-held power tool, may be attained when the hand-held power tool includes an actuating element for adjusting a spindle lock function and/or an actuating element for switching a motor unit of the hand-held power tool on and off, the actuating element being coupled with the anti-rotation lock element. The term “spindle lock function” refers, in particular, to an operating function of a drive shaft in which a rotational motion of the drive shaft is blocked and a transfer of a drive torque from the drive shaft to the tool is thereby prevented. The term “coupled” is intended to mean, in particular, an electrical, electronic, and/or—particularly advantageously—a mechanical coupling between the anti-rotation lock element and the actuating element.

It is also provided that the hand-held power tool includes a fan, which is provided to generate an air flow for moving the anti-rotation lock element into an anti-rotation lock position, thereby making it advantageously possible to couple the anti-rotation lock to an operation and/or an active state of the hand-held power tool and/or the tool. The fan is preferably driven during operation by a shaft that is provided to transfer drive torque to the tool.

Particularly advantageously, the hand-held power tool includes at least one ventilation opening for air to exit, the anti-rotation lock element being located downstream of the ventilation opening in a direction of flow of the air, thereby making it possible for the anti-rotation lock element to be moved into an anti-rotation lock position using the air flow.

In an advantageous refinement of the present invention, it is provided that the guard anti-rotation lock includes at least one anti-rotation lock element, which is located on the guard unit. As a result, it is possible to realize an anti-rotation lock with a simple design, in particular when the anti-rotation lock element interacts with an anti-rotation lock element of the hand-held power tool in a form-fit and/or non-positive manner. Particularly advantageously, the anti-rotation lock element is located, at least partially, on a clamping band, and/or on a guard collar of a guard of the guard unit.

Particularly advantageously, the present invention includes a hand-held power tool for a rotating, preferably disk-shaped tool, with a hand-held power tool housing that includes a flange and/or a machine neck, on which a guard—that is composed of sheet metal in particular—is detachably clampable in order to cover the tool. The guard includes a guard body, which is composed of a circular disk-shaped piece, in particular with an outer edge located at a right angle thereto, and with a central, circular recess, on the edge of which a guard connection piece and/or collar is formed and that includes an annular clamping band that may be tightened using a clamping means. An anti-rotation lock that acts between the machine neck and the guard is located between the guard and the machine neck and is designed as a profiled structure. The guard may be repeatedly coupled via the clamping band and/or the clamping means in its clamping position in a form-fit and/or non-positive manner with the machine neck, and is therefore capable of being fixed in a non-rotatable position and, to attain a release position, may be disengaged from the form-fit and/or non-positive connection, so that the guard may then be adjusted in a rotational manner.

### DRAWING

Further advantages result from the description of the drawing, below. Exemplary embodiments of the present invention are shown in the drawing. The drawing, the description, and the claims contain numerous features in combination. One skilled in the art will also advantageously consider the features individually and combine them to form further reasonable combinations.

FIG. 1 shows an inventive hand-held power tool system in a schematic depiction,

FIG. 2 shows an exploded view of sections of a hand-held power tool system with a hand-held power tool, a guard unit, and a guard anti-rotation lock,

FIG. 3 shows a partial view of the hand-held power tool system with an alternative anti-rotation lock that is coupled with a spindle lock function of the hand-held power tool,

FIG. 4 shows a partial view of the hand-held power tool system with an alternative anti-rotation lock that is coupled with a fan of the hand-held power tool,

FIG. 5 shows a partial view of the hand-held power tool system with an alternative guard anti-rotation lock that includes an additional fan, and

FIG. 6 shows a partial view of the hand-held power tool system with an alternative guard anti-rotation lock that includes an additional shaft.

### DESCRIPTION OF THE EXEMPLARY EMBODIMENTS

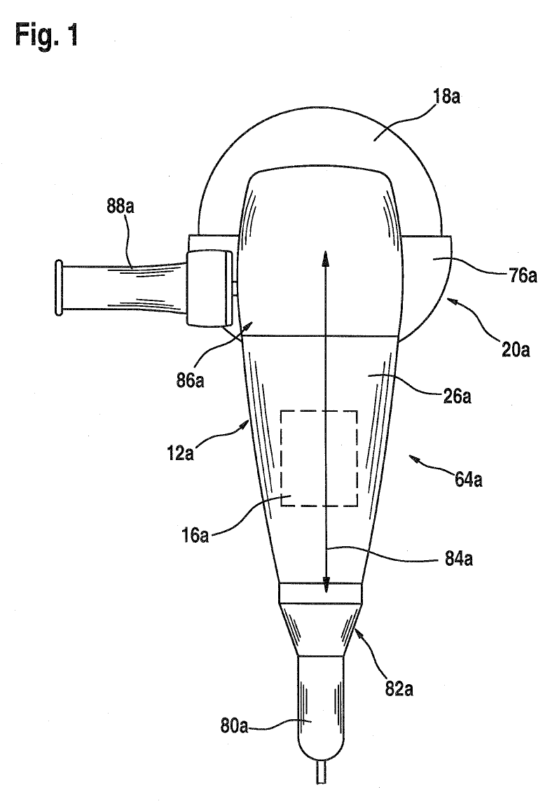

FIG. 1 shows a hand-held power tool system 64a with a hand-held power tool 12a designed as an angle grinder, and with a guard unit 20a, in a view from above. The angle grinder includes a hand-held power tool housing 26a, a motor unit 16a, and a main handle 80a integrated in hand-held power tool housing 26a. Main handle 80a extends on a side 82a facing away from a tool 18a that is a cutting disk, in a longitudinal direction 84a of the angle grinder. An auxiliary handle 88a is located in a front region 86a of the angle grinder that is close to the tool, and extends transversely to longitudinal direction 84a of the angle grinder.

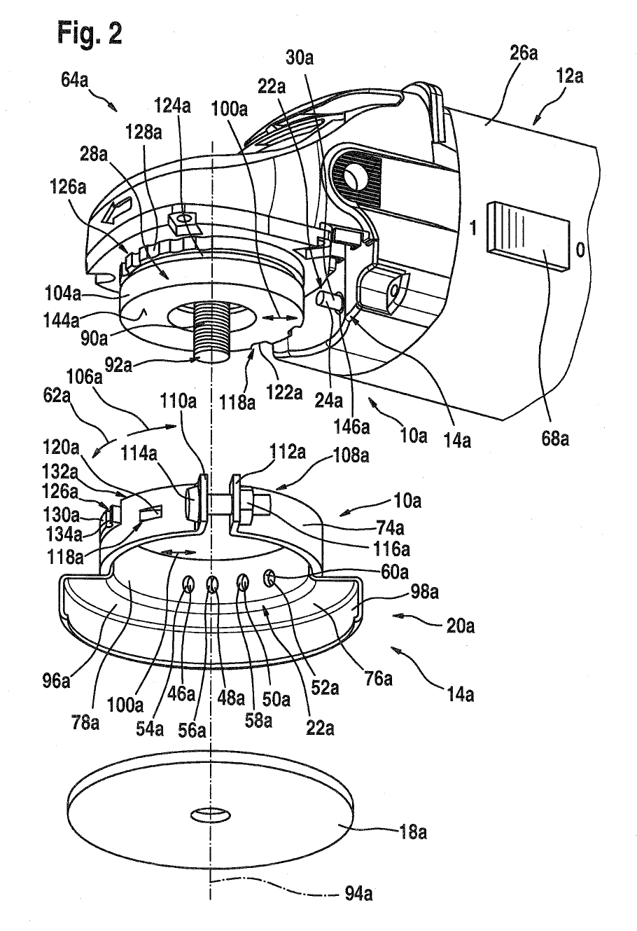

FIG. 2 shows hand-held power tool system 64a with hand-held power tool 12a, guard unit 20a, and a guard anti-rotation lock 10a, in sections. Guard anti-rotation lock 10a includes an anti-rotation lock unit 14a, which is provided to account for at least one operating parameter of hand-held power tool 12a when preventing rotation. To accommodate guard unit 20a and/or tool 18a, hand-held power tool 12a includes a hand-held power tool receiving unit 28a, which is screwed together with hand-held power tool housing 26a of hand-held power tool 12a. A drive shaft 90a extends out of hand-held power tool receiving unit 28a on a side 144a facing away from hand-held power tool housing 26a. Drive shaft 90a is connectable at its free end 92a with disk-shaped tool 18a and is rotationally drivable around an axis 94a. Axis 94a of drive shaft 90a is oriented perpendicularly to longitudinal direction 84a of hand-held power tool 12a. Guard unit 20a includes a guard 76a and a clamping band 74a. Guard 76a extends around an angular range of tool 18a of approximately 180° and, to this end, includes a semi-disk shaped guard body 96a and a guard edge 98a, which is initially oriented perpendicularly to semi-disk shaped body 96a and is finally oriented parallel to semi-disk shaped guard body 96a, inwardly in a radial direction 100a.

Guard unit 20a also includes a guard collar 78a, which is oriented essentially perpendicularly to semi-disk shaped guard body 96a. Guard collar 78a is enclosed outwardly in radial direction 100a by clamping band 74a. Guard collar 78a and clamping band 74a are interconnected via a welded connection. Guard collar 78a—together with clamping band 74a—is provided to attach guard unit 20a to hand-held power tool 12a and/or to hand-held power tool receiving unit 28a, which includes a cylindrical receiving flange 104a for this purpose. Along a circumferential direction 62a, 106a of clamping band 74a, clamping band 74a includes two end regions 110a, 112a in a region 108a that faces away from guard 76a and extends outwardly in radial direction 100a. End regions 110a, 112a each include a recess through which a clamping element 114a designed as a clamping screw extends. The clamping screw may be fastened in the recesses of clamping band 74a using a nut 116a. A diameter of clamping band 74a may be varied using the clamping screw, thereby allowing guard unit 20a to be attached in a non-positive manner to receiving flange 104a of hand-held power tool 12a using a frictional connection.

Anti-rotation lock unit 14a secures guard unit 20a against accidental rotation during operation and/or when hand-held power tool 12a is in an active state, e.g., in particular, if tool 18a should become damaged, e.g., if tool 18a should burst, thereby providing advantageous protection for an operator of hand-held power tool 12a. Anti-rotation lock 14a is sized such that the strong forces of outwardly slung tool parts that produced when the tool becomes damaged are absorbed. To this end, guard anti-rotation lock 10a includes a form-fit unit 22a, which is provided to establish a form-fit connection between guard unit 20a and receiving flange 104a of hand-held power tool 12a. To establish the form-fit connection, form-fit unit 22a and/or anti-rotation lock 14a include(s) an anti-rotation lock element 24a that is designed as a form-fit element 30a and is located on hand-held power tool housing 26a of hand-held power tool 12a. Form-fit element 30a is designed as a cylindrical bolt that is movably supported in hand-held power tool housing 26a, which includes a recess 146a for this purpose. As viewed from axis 94a, the bolt is supported in hand-held power tool housing 26a such that it is movable perpendicularly to axis 94a along radial direction 100a.

Anti-rotation lock unit 14a and/or form-fit unit 22a include further anti-rotation lock elements 46a, 48a, 50a, 52a, each of which is designed as a form-fit element 54a, 56a, 58a, 60a, and which are located on guard unit 20a. Anti-rotation lock elements 46a, 48a, 50a, 52a are located one after the other in circumferential direction 62a, 106a on clamping band 74a and guard collar 78a of guard unit 20a, and are designed as circular recesses. During operation and/or in the active state of hand-held power tool 12a, the bolt extends through one of the recesses, thereby securing guard unit 20a against rotation on hand-held power tool 12a. To this end, the bolt is coupled to a switching mechanism—only a portion of which is shown—of hand-held power tool 12a and, therefore anti-rotation lock unit 14a is coupled to an operating parameter of hand-held power tool 12a. The switching mechanism includes an actuating element 68a of hand-held power tool 12a that is coupled to motor unit 16a, so that an operator may switch motor unit 16a on or off using actuating element 68a. The operating parameter of hand-held power tool 12a is represented by a switched-on position of actuating element 68a. Via the coupling of the bolt to the switching mechanism, the bolt is located—when hand-held power tool 12a is in a switched-off state—in a recessed and/or inactive position inside hand-held power tool housing 26a of hand-held power tool 12a, and an anti-rotation lock between guard unit 20a and hand-held power tool 12a is released. A position of guard unit 20a on receiving flange 104a may be changed only in the inactive position.

When an operator presses actuating element 68a into a switched-on position, the bolt is therefore moved along radial direction 100a in the direction of receiving flange 104a, and thereby engages in one of the recesses in guard unit 20a. At the same time, hand-held power tool 12a is in an active state, and motor unit 16a may be started. When guard unit 20a and/or the recesses are located in a position on receiving flange 104a that is rotated relative to the bolt, thereby preventing an anti-rotation lock of the bolt with one of the recesses, the bolt may be moved only partially along radial direction 100a when hand-held power tool 12a is switched on. The bolt is therefore in a position that deviates from an anti-rotation lock position, and motor unit 16a is prevented from being switched on using actuating element 68a. It is also basically feasible, however, for anti-rotation lock unit 14a to be provided with a detection means that is capable of detecting when a guard unit 20a is installed on hand-held power tool 12a and advantageously prevents hand-held power tool 12a from being operated when guard unit 20a is not present.

Furthermore, hand-held power tool system 64a includes a coding device 118a, which is provided to prevent tools 18a and/or tools 18a together with guard unit 20a from being installed on unsuitable hand-held power tools 12a. To this end, clamping band 74a includes a coding element 120a of coding unit 118a, which is designed as a single piece with clamping band 74a. Coding element 120a is designed as a pressed-out region that extends inwardly in radial direction 110a and has a rectangular shape. Correspondingly, receiving flange 104a includes a coding element 122a of coding device 118a, which is designed as a recess into which coding element 120a of clamping band 74a may be inserted when guard unit 20a is installed on hand-held power tool 12a. After guard unit 20a has been inserted onto hand-held power tool receiving unit 28a, guard unit 20a may be rotated into a working position. To this end, receiving flange 104a includes a groove 124a that extends in circumferential direction 62a, 106a, in which coding element 120a is guided when guard unit 20a is rotated into the working position. At the same time, guard unit 20a is captively located on hand-held power tool 12a via groove 124a and coding element 120a.

To make it easier for an operator to attach guard unit 20a and/or to change the position of installed guard unit 20a on receiving flange 104a of hand-held power tool 12a, hand-held power tool system 64a includes a positioning device 126a. Positioning device 126a includes several positioning elements 128a on receiving flange 104a, which are located one after the other in circumferential direction 62a, 106a, and each of which is designed as an indentation. Positioning elements 128a are located along axis 94a in a region of receiving flange 104a that faces away from tool 18a. Guard unit 20a also includes a positioning element 130a of positioning device 126a, which is designed as a single piece with clamping band 74a. Positioning element 130a is located along axis 94a in an edge region 132a of clamping band 74a. When guard unit 20a is installed on tool 18a, edge region 132a faces away from tool 18a. Positioning element 130a is designed as a segment in circumferential direction 62a, 106a. Positioning element 130a is punched out of clamping band 74a along two sides that face clamping band 74a, and it is located in an end region in circumferential direction 62a, 106a on clamping band 74a. On a free end 134a in circumferential direction 62a, 106a, positioning element 130a includes a pressed-out region that extends inwardly in radial direction 1 00a and has a contour that is essentially identical in shape to a contour of positioning elements 128a of receiving flange 104a.

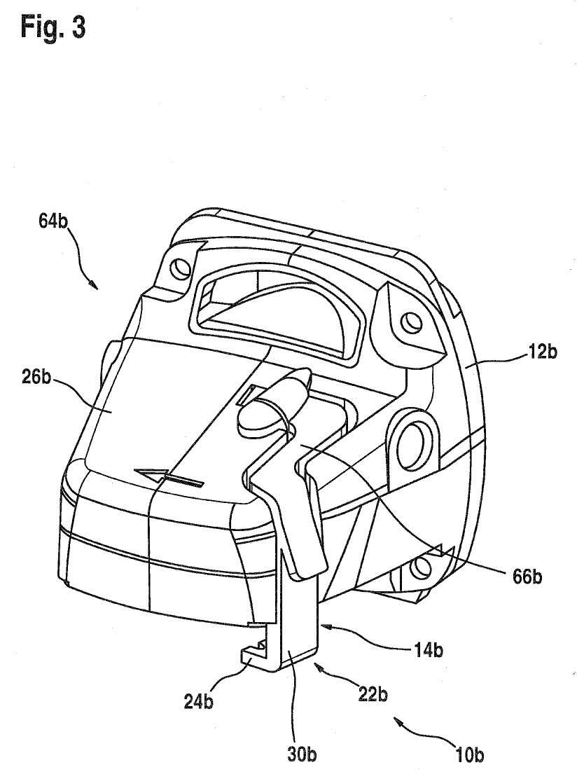

Alternative exemplary embodiments are shown in FIGS. 3 through 6. Components, features, and functions that are essentially the same are labelled with the same reference numerals. To distinguish the exemplary embodiments from each other, the reference numerals of the exemplary embodiments are appended with the letters a through e. The description below is essentially limited to the differences from the exemplary embodiment in FIGS. 1 and 2. With regard for the components, features, and functions that remain the same, reference is made to the description of the exemplary embodiment in FIGS. 1 and 2.

FIG. 3 shows a partial sectional view of a hand-held power tool system 64b that is an alternative to that shown in FIG. 2. Hand-held power tool system 64b includes a guard anti-rotation lock device 10b with an anti-rotation lock unit 14b that includes an anti-rotation lock element 24b designed as a form-fit element 30b and located on a hand-held power tool 12b. Form-fit element 30b is formed by a toothing, which, in an anti-rotation lock position, engages in a not-shown form-fit element of a guard unit that corresponds to the toothing. Form-fit element 30b of hand-held power tool 12b is designed as a single piece with an actuating element 66b of hand-held power tool 12b. Actuating element 66b is provided for adjusting a spindle lock function, so that an anti-rotation lock between the guard unit and hand-held power tool 12b is coupled to an operating parameter, which includes an active state of hand-held power tool 12b in which torque is transferred to a tool. When actuating element 66b is located in a spindle lock function, i.e., a rotation of a not-shown drive shaft of hand-held power tool 12b for driving the tool is blocked, form-fit elements 30b are disengaged, and an operator may remove or install the guard and/or the tool. When the spindle lock function has been released by actuating element 66b, an anti-rotation lock between the guard unit and hand-held power tool 12b is therefore realized simultaneously via the two form-fit elements 30b, and a blocking of the drive shaft is released.

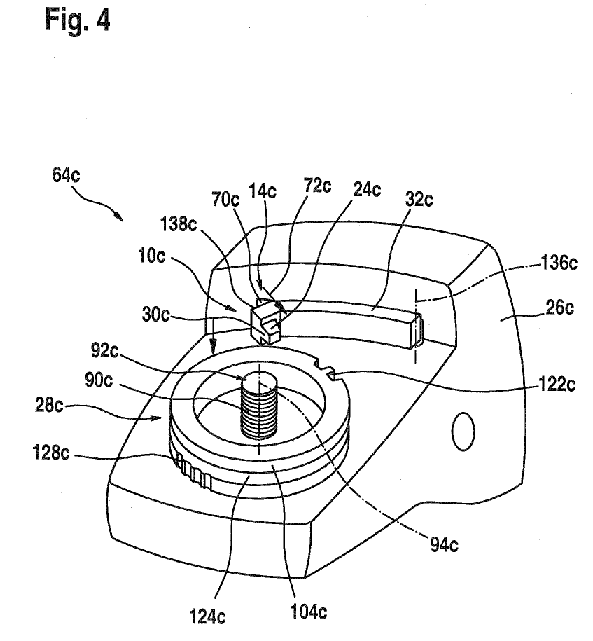

FIG. 4 shows a partial sectional view of a hand-held power tool system 64c that is an alternative to that shown in FIGS. 2 and 3. Hand-held power tool system 64c includes a guard anti-rotation lock device 10c with an anti-rotation lock unit 14c, which includes an anti-rotation lock element 24c designed as a form-fit element 30c, which is a detent cam. Anti-rotation lock element 24c is designed as a single piece with a lever element 32c of anti-rotation lock unit 14c. Lever element 32c is rotatably located on hand-held power tool 12c. Hand-held power tool 12c and/or anti-rotation lock unit 14c also include(s) a fan, which is provided to generate an air flow during operation of hand-held power tool 12c, and which is located inside a hand-held power tool housing 26c. To this end, ventilation openings 70c designed as air outlet openings are located on hand-held power tool housing 26c, through which the air flow exits during operation of hand-held power tool 12c. In flow direction 72c, lever element 32c is located downstream of ventilation openings 70c in hand-held power tool housing 26c. In an active state and/or during operation of hand-held power tool 12c, lever element 32c is pushed away from hand-held power tool housing 26c in the direction of a receiving flange 104c and/or a guard unit, and anti-rotation lock element 24c is moved into an anti-rotation lock position with the guard unit. To disengage form-fit element 30c located on lever element 32c from guard unit when hand-held power tool 12c is in a switched-off state, lever element 32c is rotatably supported using a not-shown spring element. Lever element 32c may be moved back into its home position using a spring force of the spring element. Form-fit element 30c is located on an end 138c of lever element 32c that faces away from a rotation axis 136c of lever element 32c.

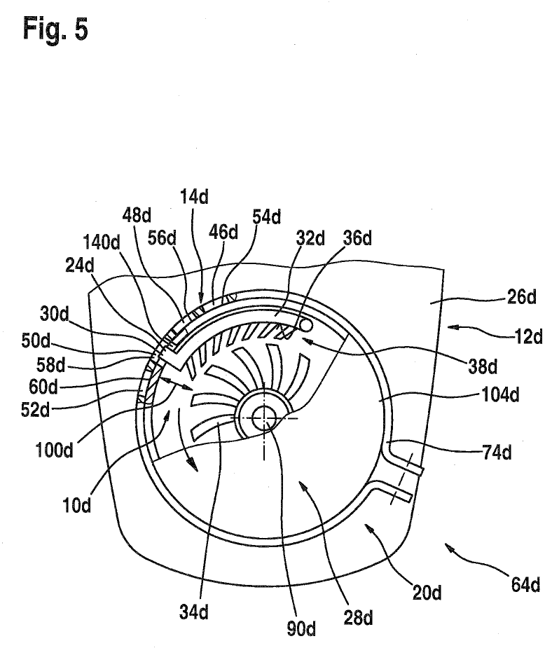

FIG. 5 shows a partial sectional view of a hand-held power tool system 64d that is an alternative to that shown in FIGS. 2 and 4. Hand-held power tool system 64d includes a guard anti-rotation lock device 10d with an anti-rotation lock unit 14d, which includes an anti-rotation lock element 24d designed as a form-fit element 30d, which is a detent cam. Anti-rotation lock element 24d is designed as a single piece with a lever element 32d of anti-rotation lock unit 14d. Lever element 32d is rotatably located on hand-held power tool receiving unit 28d of hand-held power tool 12d. In addition, a fan 34d is located inside hand-held power tool receiving unit 28d. An operation of fan 34d is coupled to an operation of a tool and/or a transfer of a drive torque to a drive shaft 90d. Lever element 32d is supported via a not-shown spring element such that it is movable outwardly along a radial direction 100d between fan 34d and a receiving flange 104d of hand-held power tool receiving unit 28d. Receiving flange 104d includes a recess 140d through which the detent cam extends during operation of hand-held power tool 12d and, with form-fit elements 54d, 56d, 58d, 60d of guard unit 20d designed as recesses, prevents guard from rotating. Lever element 32d also includes a chamber-type recess 38d on a side 36d facing fan 34d, through which an effect of the force of the air flow is increased in order to move anti-rotation lock element 24d into an anti-rotation lock position. Anti-rotation lock element 24d is moved back out of the anti-rotation lock position after operation of hand-held power tool 12d in a manner analogous to that described with reference to FIG. 4.

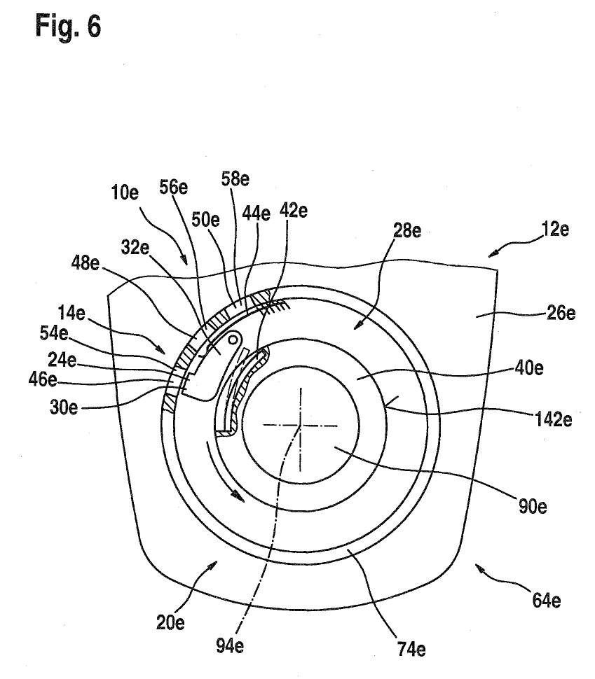

FIG. 6 shows a partial sectional view of a hand-held power tool system 64e that is an alternative to that shown in FIGS. 2 and 5. Hand-held power tool system 64e includes a guard anti-rotation lock device 10e with an anti-rotation lock unit 14e, which includes an anti-rotation lock element 24e designed as a form-fit element 30e, which is a detent cam, and which is located inside hand-held power tool receiving unit 28e of a hand-held power tool, in a manner analogous to that described with reference to FIG. 5. To move the detent cam into an anti-rotation lock position, anti-rotation lock unit 14e includes a shaft 40e designed as a hollow shaft, which is non-rotatably coupled with a drive shaft 90e. An eccentric element 42e designed as a leaf spring is located on shaft 40e on a radially outwardly directed side 142e. During operation of hand-held power tool 12e, eccentric element 42e is pressed outwardly against lever element 32e by the centrifugal forces acting on the leaf spring when drive shaft 90e rotates around an axis 94e (shown in FIG. 6 as a dashed line). This creates a radially outwardly acting force on lever element 32e, so that the detent cam located on lever element 32e engages in an anti-rotation lock element 46e, 48e, 50e of a guard unit 20e provided to prevent rotation and designed as a recess. Anti-rotation lock unit 14e also includes a restoring element 44e that is designed as a spring element, and that moves anti-rotation lock element 24e and/or lever element 32e out of an anti-rotation lock position and into a starting position as soon as a transfer of drive torque via drive shaft 90e to the tool has been halted, and/or as soon as operation of hand-held power tool 12e has been halted.

What is claimed is:

1. A guard anti-rotation lock for a hand-held power tool (12a-e), in particular for an angle grinder, characterized by an anti-rotation lock unit (14a-e), which is provided to take into account at least one operating parameter of the hand-held power tool (12a-e) when preventing rotation.

2. The guard anti-rotation lock as recited in claim 1, wherein
the anti-rotation lock unit (14a-e) is provided to account for an active state of the hand-held power tool (12a-e).

3. The guard anti-rotation lock as recited in claim 1,
wherein
the anti-rotation lock unit (14a-e) is provided to prevent rotation between a guard unit (20a-e) and the hand-held power tool (12a-e) when a tool (18a-e) becomes damaged.

4. The guard anti-rotation lock as recited in claim 3, characterized by a form-fit unit (22a-e), which is provided to establish a form-fit connection between the guard unit (20a-e) and the hand-held power tool (12a-e).

5. A hand-held power tool, in particular an angle grinder, with a guard anti-rotation lock (10a-e) as recited in claim 1,
wherein
the anti-rotation lock unit (14a-e) includes at least one anti-rotation lock element (24a-e), which is located on a hand-held power tool housing (26a-c) and/or a hand-held power tool receiving unit (28d-e).

6. The hand-held power tool as recited in claim 5,
wherein
the anti-rotation lock element (24a-e) is formed at least partially by a form-fit element (30a-e).

7. The hand-held power tool as recited in claim 5,
wherein
the anti-rotation lock element (24a-e) is movably located on the hand-held power tool housing (26a-c) and/or the hand-held power tool receiving unit (28d-e).

8. The hand-held power tool as recited in claim 5,
wherein
the anti-rotation lock element (24a-e) includes a rotatably supported lever element (32c-e) on which the anti-rotation lock element (24c-e) is at least partially located.

9. The hand-held power tool as recited in claim 5,
wherein
the anti-rotation lock unit (14c-d) includes a fan (34d), which is provided to generate an air flow for moving the lever element (32c-d) into an anti-rotation lock position.

10. The hand-held power tool as recited in claim 8,
wherein
the lever element (32d) includes—at least partially—a chamber-like recess (38d) on a side (36d) that faces the fan (34d).

11. The hand-held power tool as recited in claim 5,
wherein
the anti-rotation lock unit (14e) includes a shaft (40e) with an eccentric element (42e), which is provided for moving the anti-rotation lock element (24e) into an anti-rotation lock position.

12. The hand-held power tool as recited in claim 5,
wherein
the anti-rotation lock unit (14e) includes at least one restoring element (44e), which is provided for moving the anti-rotation lock element (24e) into an inactive position.

13. The hand-held power tool as recited in claim 12,
wherein
the restoring element (44e) is designed as a spring element.

14. A guard unit with a guard anti-rotation lock (10a-e) as recited in claim 1,
wherein
the anti-rotation lock unit (14a-e) includes at least one anti-rotation lock element (46a-e, 48a-e, 50a-e, 52a-d), which is located on a guard (76a-e) and/or a clamping band (74a-e).

15. The guard unit as recited in claim 14,
wherein
the anti-rotation lock element (46a-e, 48a-e, 50a-e, 52a-d) is a form-fit element (54a-e, 56a-e, 58a-e, 60a-d) that is provided to establish a form-fit connection with the hand-held power tool (12a-e).

16. The guard unit as recited in claim 14,
wherein
the anti-rotation lock unit (14a-e) includes at least two anti-rotation lock elements (48a-e, 50a-e, 52a-e, 54a-d), which are located one after the other in a circumferential direction (62a-e, 106a-e).

17. A hand-held power tool system with a hand-held power tool (12a-e), in particular an angle grinder, that includes a hand-held power tool receiving unit (28a-e) for receiving a disk-shaped tool (18a-e), a guard unit (20a-e), and a guard anti-rotation lock (10a-e) as recited in claim 1,
wherein
the guard anti-rotation lock (10a-e) includes an anti-rotation lock unit (14a-e), which is provided to couple an anti-rotation lock between the guard unit (20a-e) and the hand-held power tool (12a-e) at least partially to an operating parameter of the hand-held power tool (12a-e).

18. The hand-held power tool system as recited in claim 17,
wherein
the anti-rotation lock unit (14a-e) includes an anti-rotation lock element (24a-e), which is movably located on a hand-held power tool housing (26a-c) and/or the hand-held power tool receiving unit (28d-e) of the hand-held power tool (12a-e).

19. The hand-held power tool system as recited in claim 18,
wherein
the hand-held power tool (12b) includes an actuating element (66b) for adjusting a spindle lock function, which is coupled with the anti-rotation lock element (24b).

20. The hand-held power tool system as recited in claim 18,
wherein
the hand-held power tool (12a) includes an actuating element (68a) for switching a motor unit (16a) of the hand-held power tool (12a) on and off, and which is coupled with the anti-rotation lock element (24a).

21. The hand-held power tool system as recited in claim 18,
wherein
the hand-held power tool (12c-d) includes at least one fan (34d), which is provided to generate an air flow for moving the anti-rotation lock element (24c-d) into an anti-rotation lock position.

22. The hand-held power tool system as recited in claim 18,
wherein
the hand-held power tool (12c) includes at least one ventilation opening (70c) for air outflow, and the anti-rotation lock element (24c) is located downstream of the ventilation opening (70c) along a flow direction (72c) of air.

23. The hand-held power tool system as recited in claim 17,
wherein
the anti-rotation lock unit (14a-e) includes at least one anti-rotation lock element (46a-e, 48a-e, 50a-e, 52a-d), which is located on the guard unit (20a-e).

24. The hand-held power tool system as recited in claim 23,
wherein
the guard unit (20a-e) includes a clamping band (74a-e) and a guard (76a-e) with a guard collar (78a-e), and the anti-rotation lock element (46a-e, 48a-e, 50a-e, 52a-e) is located—at least partially—on the clamping band (74a-e) and/or the guard collar (78a-e).
